(19) United States
(12) Patent Application Publication
(10) Pub. No.: US 2006/0182064 A1
(43) Pub. Date: Aug. 17, 2006

(54) Interference counter-measures for wireless LANs

(75) Inventors: Roger Durand, Amherst, NH (US); Michael Yuen, Waltham, MA (US)

Correspondence Address: McGUINNESS & MANARAS LLP, 125 NAGOG PARK, ACTON, MA, 01720, US

(73) Assignee: Autocell Laboratories, Inc.

(21) Appl. No.: 11/102,954

(22) Filed: Apr. 11, 2005

Related U.S. Application Data
(60) Provisional application No. 60/649,799, filed on Feb. 3, 2005.

(51) Int. Cl. H04Q 7/00

(52) U.S. Cl. 370/332

(57) ABSTRACT

In a wireless network an access point and/or wireless end device is operable in response to interference from another device to capture a sample of the interference, determine whether the interference originates from a known type of device, and prompt remedial actions based on whether the interference originates from a known type of device. The access point may include a table of known interference signatures and a table of counter measure plans, each interference signature being associated with a particular counter measure plan. Remedial actions include changing to an alternate operating channel and/or changing signal transmission characteristics.

### CROSS-REFERENCE TO RELATED APPLICATIONS

A claim of priority is made to U.S. Provisional Patent Application Ser. No. 60/649,799, entitled Interference Counter Measures for Wireless LANs, filed Feb. 3, 2005, which is incorporated herein by reference.

### FIELD OF THE INVENTION

This invention is generally related to wireless communications, and more particularly to coping with interference.

### BACKGROUND OF THE INVENTION

Some wireless LAN (“WLAN”) products operate in unregulated spectrum. One such example is products based on the IEEE 802.11 standard. One problem associated with operating in unregulated spectrum is an increased potential, relative to regulated spectrum, of encountering interference from other devices. Some of the potential interfering devices are standards-compliant communications devices. Hence, there is at least a possibility of negotiating strategies for coping with interference via a standards organization. However, some of the potential interfering devices are not standards-compliant, or are not even communications devices. There is therefore a need for techniques and devices for coping with interference.

### SUMMARY OF THE INVENTION

A technique for coping with interference in a wireless network includes recognizing the existence of the interference; obtaining a sample of the interference; and selecting a remedial action. The remedial action may be selected by matching the interference sample with a stored interference pattern associated with a particular remedial action. In particular, the stored interference patterns are indicative of particular interference sources, and the remedial actions associated with the stored interference patterns are designed to better cope with the particular interference source indicated by the pattern. Remedial actions may include changing to an alternate operating channel and changing the transmission characteristics of the signal.

A wireless access point or at least one wireless end device may include processing logic operable to recognize the existence of interference; sampling logic operable to obtain a sample of the interference; search logic operable to determine whether the interference originates from a known type of device; and selection logic operable to select a remedial action based at least in-part on whether the interference originates from a known type of device. The search logic and selection logic may be implemented with tables in storage. In particular, a table of digital interference patterns may be maintained in which each table entry is linked with at least one entry in a table of counter measure plans.

The invention offers improved WLAN performance when interference is encountered. For example, the remedial actions may enable communications between an end station and an access point to be maintained or re-enabled where communications would otherwise be broken in known configurations. By recognizing a particular source of interference it may be possible to continue communications on the channel by implementing counter measures calculated to overcome the identified interference source. Further, if the interference source cannot be identified or if other counter measures are unsuccessful then it may be possible maintain communications between the end station and the access point by changing to an alternate channel. Maintaining communications may be less disruptive than breaking a communications link and re-authenticating on a different channel.

For interference sources which exhibit a pulse waveform the interference sources are analyzed based on pulse period and duration. This format offers the advantage of being relatively compact.

### BRIEF DESCRIPTION OF THE FIGURES

FIG. 1 is a block diagram of a wireless access point and end station adapted for coping with interference.

FIG. 2 is a flow diagram illustrating a technique for coping with interference.

FIG. 3 is a waveform diagram that illustrates interference characterization.

### DETAILED DESCRIPTION

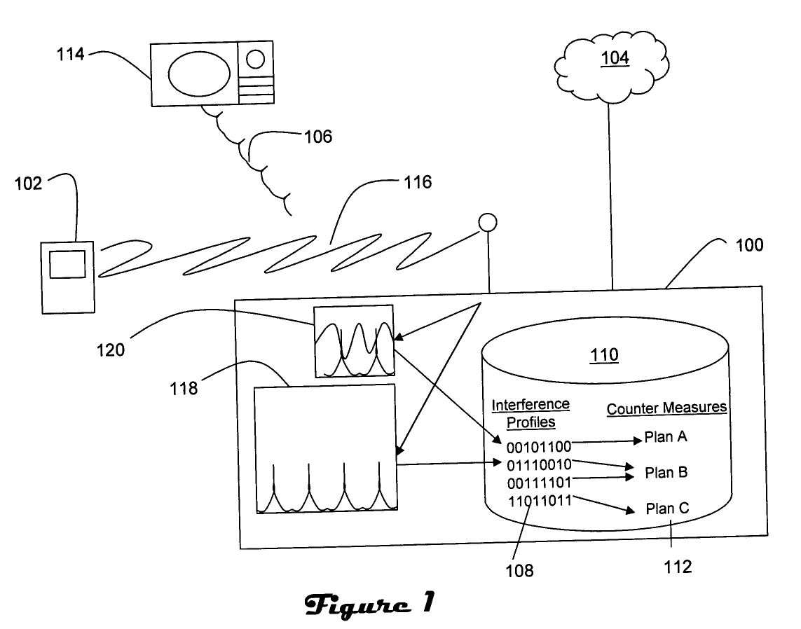

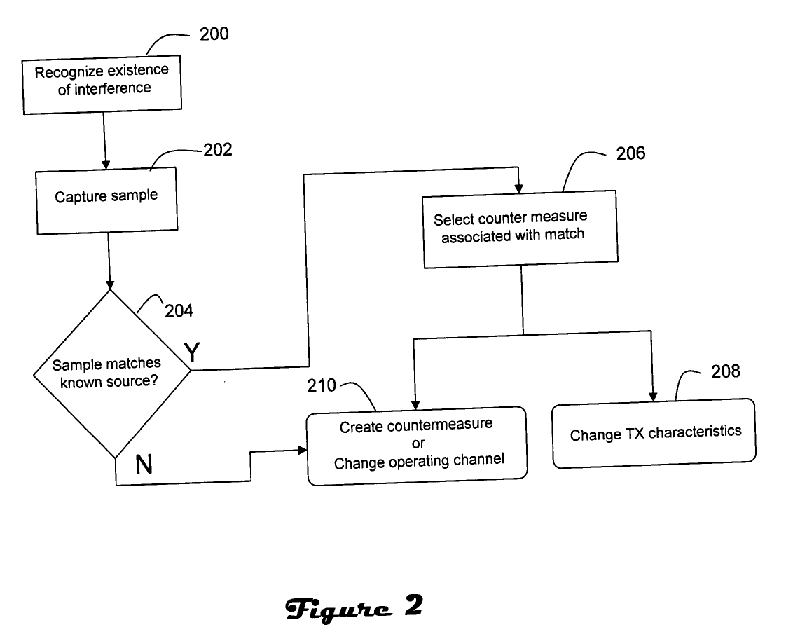

Referring to FIGS. 1 and 2, a wireless access point (100) is operative to provide network access to a wireless end station (102) such as a personal computer, PDA, notebook computer or phone. The end station (102) is typically a mobile device without wireline connections, whereas the access point (100) is typically a stationary device having a wireline connection with another network device such as switch, router or server in a network (104). Communications between the access point (100) and the end station (102) are typically two-way, and may utilize one or more channels within a predefined spectrum.

The access point (100) is adapted to recognize and respond to interference (106) generated by a device (114) other than the end station (102). For example, the access point includes a table (108) of interference profiles in memory (110) which are indicative of particular sources of interference. The memory (110) also includes a table (112) of counter measure plans which specify actions to be taken when a particular source of interference is recognized. Each counter measure plan specifies at least one remedial action, such as altering transmission characteristics and/or changing to an alternate communication channel. The remedial actions may be arranged hierarchically such that multiple actions are attempted in a predefined order until a satisfactory result is obtained. Each interference profile in the table (108) is associated with at least one counter measure plan in the corresponding table (112), and multiple interference profiles may be associated with a particular counter measure plan.

The first step (200) in the technique employed by the access point (100) to cope with interference is recognizing the existence of the interference (106). The access point may recognize the interference by analyzing the signal received at the access point. For example, a quiet interval may be implemented such that the signal received at the access point does not include normal traffic (116) between the access point and end station, but rather comprises any existing interference, e.g., signal (106). An alternative to use of the quiet interval is to analyze the combination of normal traffic signal (116) and interference signal (106). For example, a parallel demodulation engine (120) may be programmed to identify, from the combined signal, types of interference that differ recognizably from actual data in the channel. Alternatively, recognition of a combined signal which has a relatively high proportion of noise or is not in a format specified by the communications protocol being utilized may be used as an indication of the presence of interference. Alternatively, some communications protocols specify use of periodic communications between an access point and end station primarily to verify that the communications link is operational. Such a protocol may also be used to recognize the existence of interference when the communications link fails for purposes of the present technique.

Once the access point recognizes the existence of interference it then captures a sample (118) of the interference as indicated in step (202) in order to attempt to identify the source of the interference. The sample may be captured by storing a portion of the interference signal (106) received at the access point. The received signal, which is analog, may then be sampled and converted to digital format for processing. Each sample measurement is associated with a time stamp indicating the relative time at which the sample was obtained. Hence, the resulting data comprises sets of energy magnitude measurements and time stamps.

Because there are different possible sources of interference, and the characteristics of the interference associated those sources may vary, the sampling rate and period are selected to capture a sufficient sample to identify all known potential sources of interference stored in the digital patterns in memory. The sample (118) is then compared with the interference profiles in table (108) to identify a match, or the absence of a match, as indicated by step (204). Alternatively, an adaptive algorithm may be employed to adjust the sampling period and rate until a match between the sample and an interference profile is located or eliminated as a possibility. If a matching interference profile is located in table (108) then the associated counter measures plan is selected as indicated by step (206). As discussed above, the counter measures plan may include one or both of changing transmission signal characteristics as indicated by step (208) and changing to an alternate operating channel as indicated by step (210). If no matching interference profile is located then the access point may devise an adaptation based on the inverse of the measured interference or it may move to the alternate operating channel as indicated by step (210).

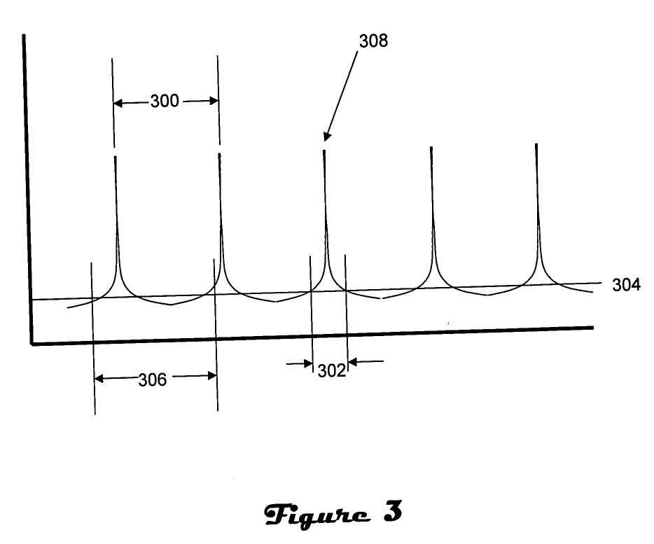

Referring to FIGS. 1 and 3, in the illustrated embodiment the data in table (108) and samples (118) represents pulse period 300. Pulse duration 302 may also be employed. Pulse period is indicative of the time between consecutive pulses, and pulse duration is indicative of the time during which an individual pulse exhibits a power level above a predetermined threshold, i.e., sampling noise floor 304. After gathering multiple data points across a sample window 306, parallel processes are executed to calculate interference signal duration and period. Interference period is determined by identifying a maximum energy point (“peak”) 308 in a window and then determining the time between that peak and a corresponding adjacent peak of similar power. Pulse duration may be calculated by finding the first samples on both sides of the peak that drop to the measurement noise floor on each side of the peak.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the invention should not be viewed as limited except by the scope and spirit of the appended claims.

What is claimed is:

1. In a wireless network having a first device and a second device, a method for coping with interference from a third device that adversely effects communications between the first device and the second device comprising the steps of:
recognizing the existence of interference;
obtaining a sample of the interference;
determining whether the interference originates from a known type of device; and
selecting a remedial action based at least in-part on whether the interference originates from a known type of device.

2. The method of claim 1 further including the steps of determining if the interference originates from an unknown type of device, and selecting a remedial action based on the obtained sample of the interference if the interference is determined to originate from an unknown type of device.

3. The method of claim 1 wherein the determining step includes the further step of attempting to identify a match between the sample and a plurality of stored interference patterns.

4. The method of claim 1 further including the step of changing to an alternate operating channel if the interference does not originate from a known type of device.

5. The method of claim 1 including the further step of changing transmission signal characteristics if the interference originates from a known type of device.

6. The method of claim 1 including the further step of sequentially implementing multiple remedial actions until an acceptable result is obtained.

7. Apparatus for use in a wireless network for coping with interference from another device comprising:
processing logic operable to recognize the existence of interference;
sampling logic operable to obtain a sample of the interference;
search logic operable to determine whether the interference originates from a known type of device; and
selection logic operable to select a remedial action based at least in-part on whether the interference originates from a known type of device.

8. The apparatus of claim 7 wherein the search logic is further operable to determine if the interference originates from an unknown type of device, and wherein the selection logic is further operable to select a remedial action based on the obtained sample of the interference if the interference is determined to originate from an unknown type of device.

9. The apparatus of claim 7 wherein the search logic is further operable to attempt to identify a match between the sample and a plurality of stored interference patterns.

10. The apparatus of claim 7 wherein the selection logic is operable to change to an alternate operating channel if the interference does not originate from a known type of device.

11. The apparatus of claim 7 wherein the selection logic is operable to change transmission signal characteristics if the interference originates from a known type of device.

12. The apparatus of claim 7 wherein the selection logic is operable to sequentially implementing multiple remedial actions until an acceptable result is obtained.

13. A wireless device for use in a wireless local area network comprising:
a memory having stored therein:
a plurality of interference signal patterns, each interference signal pattern being indicative of a source of interference; and
a plurality of counter measure plans, each specifying at least one remedial action for the associated source of interference, and each interference signal pattern being associated with a counter measure plan;
signal processing logic operable to obtain a signal sample; and
interference counter-measure logic operable to identify an interference source by matching at least some characteristics of the signal sample with at least some characteristics of a stored interference signal pattern, and to implement the at least one remedial action specified in the counter measure plan associated with the matching interference signal pattern.
